(19) United States
(12) Patent Application Publication
(10) Pub. No.: US 2025/0111793 A1
(43) Pub. Date: Apr. 3, 2025

(54) OPERATION MANAGEMENT SYSTEM

(71) Applicant: HITACHI, LTD., Tokyo (JP)

(72) Inventors: Mitsuru MATSUBARA, Tokyo (JP); Takahiro ITO, Tokyo (JP); Mikio BANDO, Tokyo (JP); Taku SHIMIZU, Tokyo (JP)

(21) Appl. No.: 18/730,861

(22) PCT Filed: Dec. 20, 2022
(86) PCT No.: PCT/JP2022/046802

§ 371 Date: Jul. 22, 2024

(30) Foreign Application Priority Data
Feb. 3, 2022 (JP) 2022-015939

(51) Int. Cl. G08G 5/80; B64C 27/04; B64C 39/02; G05D 1/229

(52) U.S. Cl. CPC G08G 5/80; B64C 27/04; B64C 39/02; G05D 1/2295

(57) ABSTRACT

An operation management system is capable of safely and space-efficiently optimizing an operation path in accordance with various events. The operation management system manages a flight of an airframe such as a vertical take-off and landing plane. The system includes a 4D path planning unit that plans a 4D path, of the airframe, represented as a series of planned passing positions and time of the airframe. The system has an occupied space design unit for designing, as occupied spaces of the airframe prohibiting entry of other airframes, a movable occupied space that includes the airframe and that moves together with a mobile body and a fixed occupied space that includes the movable occupied space and that is along the 4D path. The 4D path planning unit re-plans the 4D path on the basis of a positional relationship between the movable and fixed occupied spaces during the flight of the airframe.

### TECHNICAL FIELD

The present invention relates to an operation management system for a mobile object.

### BACKGROUND ART

In recent years, social use of an aircraft (also referred to as a “craft”) capable of vertical takeoff and landing such as a drone has attracted attention.

A vertical takeoff and landing aircraft has advantages that the runway required for the conventional fixed-wing aircraft is unnecessary and the takeoff and landing place can be made compact. Compared to an engine-driven helicopter, an electrified vertical takeoff and landing aircraft has advantages that the silent property is excellent, the greenhouse gases are not emitted in driving, the maintenance cost is low, and so on. With respect to the vertical takeoff and landing aircraft, development of a vertical takeoff and landing aircraft with a wing for extension of the cruising distance, development of a vertical takeoff and landing aircraft having a hybrid system as a power source, and so on have been proceeded energetically.

It is expected that the vertical takeoff and landing aircraft having such features enables three-dimensional transportation of people and objects utilizing the aerial regions and provides users with significant time saving of transportation and convenience. On the other hand, with respect to such application as the transportation of people and objects, increase in the number of operation is required for economic fulfillment, and improvement of operation density enabled by operation with excellent spatial efficiency is an agenda to achieve the increase in the number of operation. Also, in order to operate an aircraft stably and safely, specialized skill and professional expertise are required, and shortage of human resources becomes an agenda for increase in the number of operation. In order to solve the agenda, automation and autonomy are required for a vertical takeoff and landing aircraft and a system related to operation thereof. From such viewpoint, there is required a takeoff and landing port and a takeoff and landing operation management system enabling takeoff and landing of plural aircrafts simultaneously, safely, with excellent spatial efficiency, and automatically.

In order to allow takeoff and landing of a vertical takeoff and landing aircraft with excellent spatial efficiency and safely without collision, in a simple way, the operation management system only has to be capable of setting a proximity permission distance between the crafts (permissible value with respect to the relative distance between respective crafts) short, planning the operation route from the start point to the finish point of each craft so that the distance between respective crafts becomes equal to or greater than the proximity permission distance at all clock time, and providing the plan to each craft.

However, due to strong wind by bad weather, and impact of downwash (down blow of the wind) generated by another craft and so on for example, there is a case that the attitude and the flying position of the craft may be destabilized. Therefore, it is required that the operation management system plans an operation route so that the proximity permission distance has a sufficient length considering these risks of the external environment. Also, when there exists a flying body (referred to also as an “obstacle”) becoming a hamper of flight such as a bird, it is required that the operation management system plans an operation route considering collision risk of the craft and the obstacle. Also, when there exists an air exclusion area such as an airspace above an important facilities such as a nuclear power station and a densely populated area of a residential area and the like, it is required that the operation management system plans such operation route going around such area.

As an example of an air traffic control device planning an operation route of a craft considering such risk of the craft and restriction of the flying airspace, Patent Literature 1 can be cited.

An air traffic control device described in Patent Literature 1 divides the management area into plural areas (into a mesh shape), topographical information, meteorological information, information of an obstacle, presence and absence of the flying schedule of other crafts, and so on are tied to each area, and manages the time of flight permission/prohibition of each area. The air traffic control device described in Patent Literature 1 automatically plans the flight route of a craft of an object by connecting the flight possible areas.

### CITATION LIST

### Patent Literature

Patent Literature 1: Japanese Unexamined Patent Application Publication No. 2019-32661

### SUMMARY OF INVENTION

### Technical Problem

However, the air traffic control device described in Patent Literature 1 plans the operation route of the craft based on information linked to each area at the time point of planning of the operation route, and re-examines the operation route only in emergency landing at the time point when an emergency state occurs. That is to say, the air traffic control device described in Patent Literature 1 does not re-examine the operation route at other than the time point when an emergency state occurs during operation of the craft. Therefore, with respect to the air traffic control device described in Patent Literature 1, there is a room for improvement in terms that the operation route is to be optimized safely and with excellent spatial efficiency responding various phenomena occurring during operation.

The present invention has been achieved in view of the problem described above, and its object is to provide an operation management system capable of optimizing an operation route safely and with excellent spatial efficiency responding various phenomena occurring during operation.

### Solution to Problem

In order to solve the problem described above, the operation management system of the present invention is an operation management system for managing operation of a mobile object, the operation management system including a route planning unit that plans an operation route of the mobile object expressed as a series of a position and a clock time at which the mobile object is scheduled to pass, and an appropriable space designing unit that designs, as an appropriable space of the mobile object where entering of another mobile objects is not permitted, a moving appropriable space including the mobile object and moving along with the mobile object and a fixed appropriable space including the moving appropriable space and being along the operation route, in which the route planning unit re-plans the operation route during operation of the mobile object based on positional relation between the moving appropriable space and the fixed appropriable space.

### Advantageous Effects of Invention

According to the present invention, it is possible to provide an operation management system capable of optimizing an operation route safely and with excellent spatial efficiency responding various phenomena occurring during operation.

Problems, configurations, and effects other than those described above will be clarified by explanation of embodiments described below.

### BRIEF DESCRIPTION OF DRAWINGS

FIG. 1 is a block diagram illustrating an example of a configuration of an operation management system of the first embodiment.

FIG. 2 is a drawing explaining a state a craft flies.

FIG. 3 is a drawing illustrating a case where a fixed appropriable space is of an ellipsoidal shape, and a moving appropriable space is of a cylindrical shape.

FIG. 4 is a drawing explaining a partial 4D route.

FIG. 5 is a drawing explaining a state before connecting plural fixed appropriable spaces.

FIG. 6 is a drawing explaining a state after connecting plural fixed appropriable spaces.

FIG. 7 is a drawing explaining the relation between the fixed appropriable space and the moving appropriable space.

FIG. 8 is a drawing illustrating an example where a fixed appropriable space is of a cylindrical shape, and a moving appropriable space is of a spherical shape.

FIG. 9 is a drawing illustrating an example where a fixed appropriable space is of a spherical shape, and a moving appropriable space is of a spherical shape.

FIG. 10 is a drawing illustrating a case where orbits of 4D routes of respective crafts cross each other.

FIG. 11 is a drawing explaining a design concept of a fixed appropriable space.

FIG. 12 is a drawing explaining a management area managed by an operation management system.

FIG. 13 is a drawing explaining a design concept of a moving appropriable space.

FIG. 14 is a drawing explaining a re-planning function for a 4D route.

FIG. 15 is a block diagram explaining an alarm issuance function of a route planning device.

FIG. 16 is a drawing illustrating an example of an appropriable space designed for a managed body.

FIG. 17 is a drawing illustrating an example of an appropriable space designed for a managed body.

FIG. 18 is a drawing illustrating an example of an appropriable space designed for a managed body.

FIG. 19 is a drawing illustrating an example of an appropriable space designed for a managed body.

FIG. 20 is a flowchart of a process executed by the operation management system.

FIG. 21 is a flowchart of a process executed consecutively to FIG. 20.

FIG. 22 is a block diagram illustrating an example of a configuration of an operation management system of the second embodiment.

### DESCRIPTION OF EMBODIMENTS

Embodiments of the present invention will be hereinafter explained using the drawings. Also, a configuration marked with a same reference sign in each embodiment has a similar function in each embodiment unless expressly stated otherwise, and explanation thereof will be omitted.

The operation management system of the present invention can be applied also to a mobile object having the degree of freedom of three dimensional movement such as a spaceship or a submersible vessel other than a flying object to begin with an aircraft such as a vertical takeoff and landing aircraft. Also, the operation management system of the present invention can be applied also to a mobile object traveling on the ground such as an automobile, robot, or a railway vehicle. The mobile object to which the operation management system of the present invention is to be applied may be a mobile object moving based on maneuvering of a pilot boarding the mobile object or a remote pilot not boarding the mobile object, and may be a mobile object moving autonomically. In the present embodiment, explanation will be made for an example where the operation management system is applied to a vertical takeoff and landing aircraft that is a flying object.

### First Embodiment

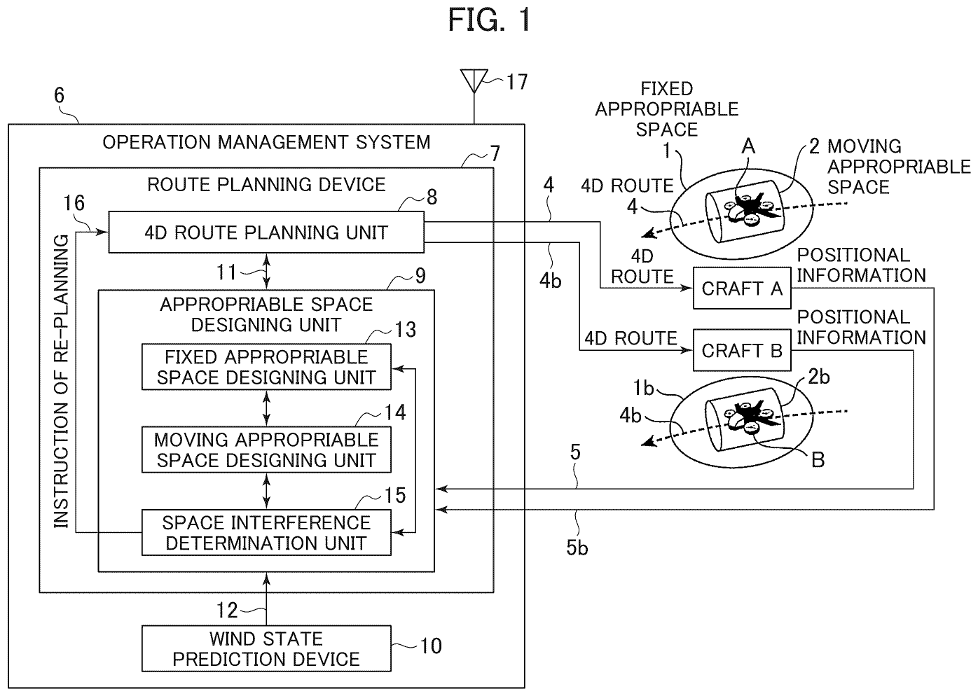

An operation management system 6 of the first embodiment will be explained using FIG. 1 to FIG. 21.

FIG. 1 is a block diagram illustrating an example of a configuration of the operation management system 6 of the first embodiment.

The operation management system 6 illustrated in FIG. 1 executes operation management and traffic control of takeoff and landing of plural crafts (vertical takeoff and landing aircrafts or fixed-wing aircrafts). According to the present embodiment, the operation management system 6 makes a craft A and a craft B the objects as an example of the plural crafts. The operation management system 6 includes a route planning device 7 planning and providing 4D routes 4, 4b depending on the flying purpose of each craft A, B, and guides each craft A, B.

4D route is an operation route of a craft expressed as a series of the position and the clock time at which the craft is scheduled to pass. That is to say, the 4D route is expressed as a time series data group of three-dimensional coordinate expressing a position where the craft is scheduled to pass. In concrete terms, the 4D route is expressed as a series of four-dimensional vectors formed of the three-dimensional coordinate and the clock time described above. Also, for the purpose of convenience of explanation, there is also a case that 4D route is simply referred to as a route.

Also, the operation management system 6 includes a wind state prediction device 10 that predicts the wind state (wind direction, wind velocity, atmospheric pressure, and the like) at each spot within the management area of the operation management system 6. The route planning device 7 plans the 4D routes 4, 4b utilizing wind state information 12 provided by the wind state prediction device 10.

Also, the operation management system 6 constantly acquires positional information 5, 5b of each craft A, B from each craft A, B. The route planning unit 7 plans the 4D route 4, 4b based on the positional information 5, 5b of each craft A, B. Instead of the fact that the operation management system 6 acquires the positional information 5, 5b measured by each craft A, B, the operation management system 6 may include a device that measures the positional information 5, 5b. As a device where the operation management system 6 measures the positional information 5, 5b, measuring devices such as LiDAR, radar, or a stereo camera can be cited for example.

Also, the hardware configuration of the operation management system 6 is not particularly limited to the configuration illustrated in FIG. 1. For example, the route planning device 7 may be configured as a part of a so-called air traffic control device. The wind state prediction device 10 may be arranged outside the operation management system 6. In this case, the operation management system 6 can include a wind state information acquisition unit that acquires the wind state information 12 transmitted from the wind state prediction device 10.

Also, the operation management system 6 can calculate the velocity of each craft A, B by differential of the positional information 5, 5b having been acquired, and can grasp the velocity of each craft A, B accompanying measurement of the positional information 5, 5b. In explanation described below, measurement of the velocity of each craft A, B is not particularly specified clearly. When the measurement error of the velocity caused by measurement error of the position of each craft A, B becomes a problem, the operation management system 6 can acquire velocity information along with the positional information 5, 5b from each craft A, B.

Also, the operation management system 6 may be configured to acquire attitude angle information of each craft A, B from each craft A, B, to plan the 4D route 4, 4b including the attitude angle information, and to provide each craft A, B with the 4D route 4, 4b including the attitude angle information. Thus, the operation management system 6 can plan the 4D route 4, 4b taking the attitude angle possibly be taken by each craft A, B into consideration. Although measurement of the attitude angle of each craft A, B is not particularly stated clearly in explanation described below, it may be considered that the 4D route to be planned includes attitude angle information of each craft A, B.

The route planning device 7 includes a 4D route planning unit 8 and an appropriable space designing unit 9. The 4D route planning unit 8 and the appropriable space designing unit 9 are configured to share information mutually through a communication interface 11.

The appropriable space designing unit 9 includes a fixed appropriable space designing unit 13, a moving appropriable space designing unit 14, and a space interference determination unit 15. The fixed appropriable space designing unit 13, the moving appropriable space designing unit 14, and the space interference determination unit 15 are configured to mutually share information. The space interference determination unit 15 is configured to instruct the 4D route planning unit 8 to re-plan the 4D route 4, 4b.

The operation management system 6 makes each craft within the own management area an object of operation management, and the route planning device 7 plans and provides a 4D route respectively to each craft within the management area. When each craft A, B is located within the management area, the route planning device 7 transmits the 4D route 4, 4b planned by the 4D route planning unit 8 to each craft A, B respectively through a communication device 17. Each craft A, B flies along the 4D route 4, 4b having been provided.

The 4D route planning unit 8 plans the 4D route 4, 4b extending from the start point to the finish point so as to achieve the flying object of each craft A, B based on a fixed appropriable space 1, 1b of each craft A, B designed by the appropriable space designing unit 9. The fixed appropriable space 1, 1b is a three-dimensional space linked to each craft A, B.

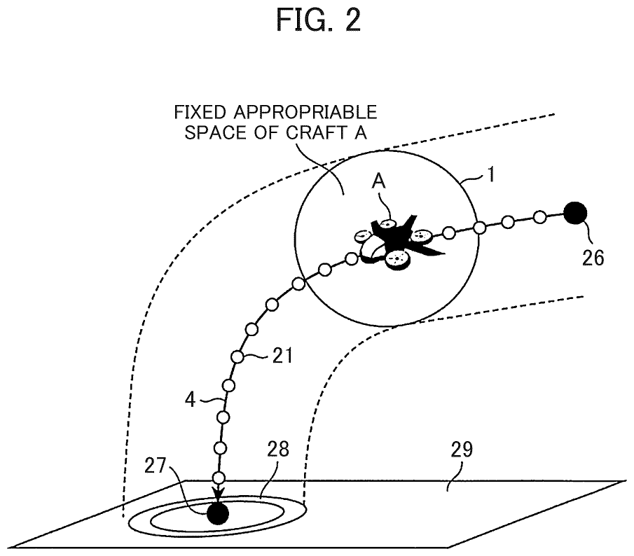

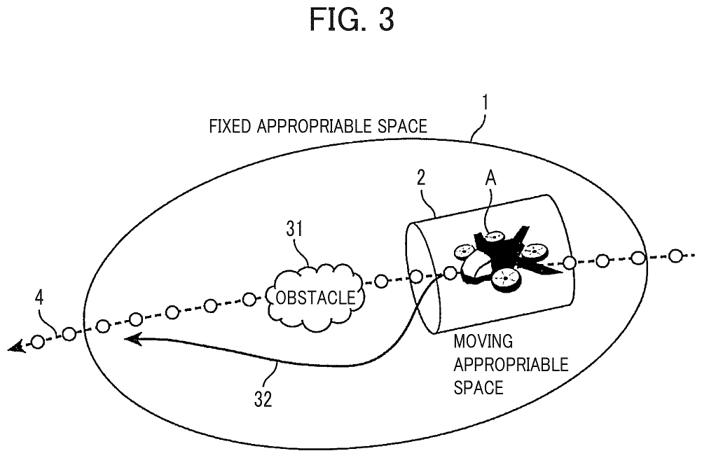

FIG. 2 is a drawing explaining a state the craft A flies. FIG. 3 is a drawing illustrating a case where the fixed appropriable space 1 of the craft A is of an ellipsoidal shape, and a moving appropriable space 2 is of a cylindrical shape.

In FIG. 2, the flying object of the craft A is landing onto a takeoff and landing port 28 on a ground surface 29. That is to say, the flying object of the craft A is movement from a start point 26 of the present position to a finish point 27 on the takeoff and landing port. When the 4D route 4 from the start point 26 to the finish point 27 has been provided by the route planning unit 7, the craft A can achieve the flying object by moving along this 4D route 4. In FIG. 2, it is meant that the 4D route 4 is expressed as a series of a four-dimensional vector 21 that is formed of three-dimensional coordinate and clock time. Also, since the start point 26 and the finish point 27 are end points of the 4D route 4, it is to be noted that the start point 26 and the finish point 27 are expressed by a four-dimensional vector that is formed of three-dimensional coordinate and clock time.

In FIG. 2, a space linked to the craft A is the fixed appropriable space 1 of the craft A. The fixed appropriable space designing unit 13 of FIG. 1 designs the fixed appropriable space 1, 1b of each craft A, B. The moving appropriable space designing unit 14 of FIG. 1 designs the moving appropriable space 2, 2b of each craft A, B. The route 4, 4b of each craft A, B is planned by the 4D route planning unit 8 based on them.

Next, the relation of the fixed appropriable space 1, the moving appropriable space 2, and the 4D route 4 will be explained.

Each of the fixed appropriable space 1 and the moving appropriable space 2 is an appropriable space of the craft A where entering of other crafts is not permitted. The moving appropriable space 2 is a space including the craft A and moving along with the craft A. The fixed appropriable space 1 is a space that includes the moving appropriable space 2 and is along the 4D route 4.

First, the moving appropriable space 2 will be explained. The moving appropriable space 2 is defined as described below. Definition (d1): The moving appropriable space 2 constantly keeps the center of gravity of the craft A within the space.

Definition (d2): Distance LM between an optional point on the boundary surface (surface) defining the moving appropriable space 2 and the center of gravity of the craft A constantly has the relation of the expression (1) below.

LM=Ra+DM (1)

Here, Ra is the maximum value of the distance between the center of gravity of the craft A and a portion of the craft A. DM is a positive number greater than zero which means DM>0. The expression (1) means that all portions of the craft A are included inside a spherical body having the radius Ra, the center of the spherical body being the center of gravity of the craft A, this spherical body is included in the moving appropriable space 2, and DM is to specify the distance between the surface of the spherical body having the radius Ra and the boundary surface (surface) of the moving appropriable space 2.

To be exact, DM is necessary in all points on the surface of the moving appropriable space 2. The relation of the moving appropriable space 2 and the craft A is given by {DM(si)|si⊂Si} by the set of DM. Here, si is an optional point on the boundary surface Si of the moving appropriable space 2. DM(si) is a positive number specifying the distance between the point si on the boundary surface of the moving appropriable space 2 and the surface of the spherical body having the radius Ra. DM is to simply specify the positional relation between the moving appropriable space 2 and the craft A. Therefore, in the present embodiment, there is a case that the positional relation between the moving appropriable space 2 and the craft A is referred to conveniently as DM.

It is assumed that the craft A moves from the coordinate p0 to the coordinate p1 from the clock time t0 to the clock time t1 (t0<t1). When DM remains unchanged during the time from the clock time t0 to the clock time t1, according to the definitions (d1) and (d2), the moving appropriable space 2 moves along with the craft A without changing the shape of the moving appropriable space 2 while maintaining the distance between the center of gravity of the craft A and the point on the boundary surface of the moving appropriable space 2.

DM of the moving appropriable space 2 does not necessary have to be a fixed value, and may be variable (may change from time to time) based on the performance, position, and velocity of the craft A and the meteorological state such as the wind state at the position of the craft A in order to plan more effective operation route.

As a result, according to the definitions (d1) and (d2), the moving appropriable space 2 is a space moving according to movement of the craft A. Further, although the spherical body having the radius Ra including the craft A is defined in the expression (1) for the sake of simplicity of explanation, it is also possible to give the relation of the expression (1) after alternatively defining more compact space including all portions of the craft A.

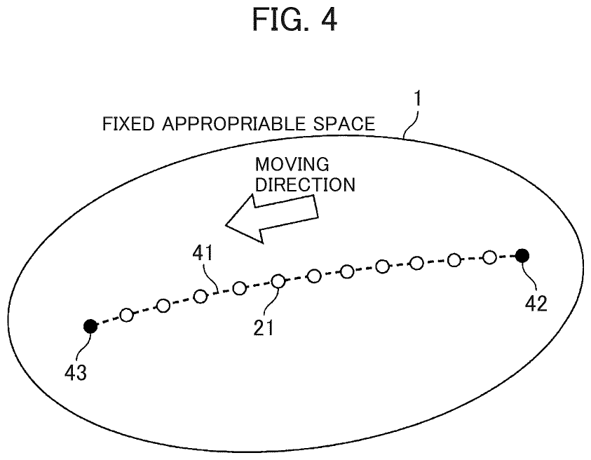

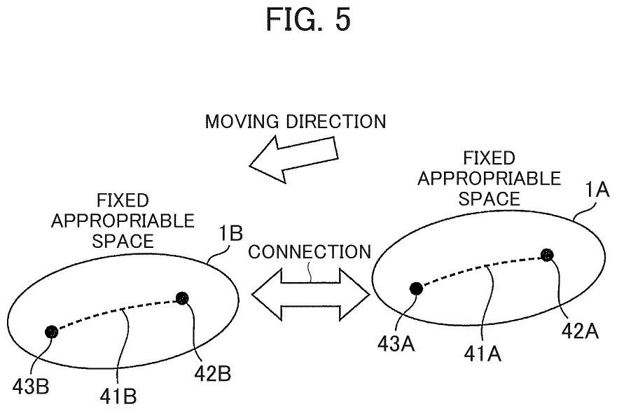

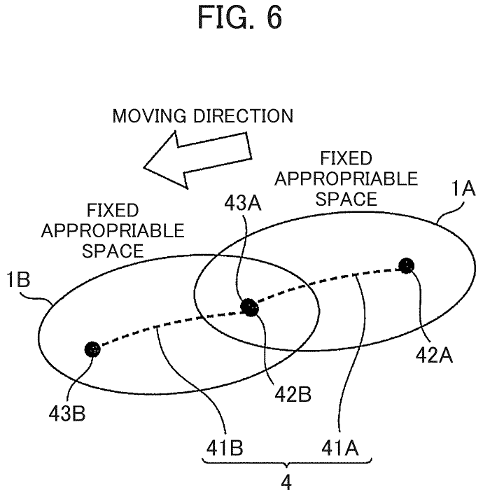

Next, the relation between the 4D route 4 and the fixed appropriable space 1 will be explained using FIG. 4 to FIG. 6. FIG. 4 is a drawing explaining a partial 4D route 41. FIG. 5 is a drawing explaining a state before connecting plural fixed appropriable spaces 1A, 1B. FIG. 6 is a drawing explaining a state after connecting the plural fixed appropriable spaces 1A, 1B.

The partial 4D route 41 configures a part of the 4D route 4. As illustrated in FIG. 4, the partial 4D route 41 is expressed as a series of the four-dimensional vector 21 formed of three-dimensional coordinate and clock time. A connection start point 42 and a connection finish point 43 are respective end points of the partial 4D route 41.

The fixed appropriable space 1 is to include the partial 4D route 41 in such state that all points of the partial 4D route 41 (all four-dimensional vectors 21) do not contact the boundary surface (surface) defining the fixed appropriable space 1.

As illustrated in FIG. 5 and FIG. 6, the 4D route 4 is to be configured by connecting a connection finish point 43A of a partial 4D route 41A included in the fixed appropriable space 1A and a connection start point 42B of a partial 4D route 41B included in the fixed appropriable space 1B. That is to say, as illustrated in FIG. 6, the 4D route 4 is configured by a series of a space as a succession of the fixed appropriable space 1A and the fixed appropriable space 1B. Although examples of connecting the partial 4D route 41A of the fixed appropriable space 1A and the partial 4D route 41B of the fixed appropriable space 1B are illustrated in FIG. 5 and FIG. 6, the number of piece of the fixed appropriable space 1 and the partial 4D route 41 configuring the 4D route 4 is not particularly limited, and may be three or more. That is to say, the 4D route 4 is to be configured as a time series of the fixed appropriable space 1.

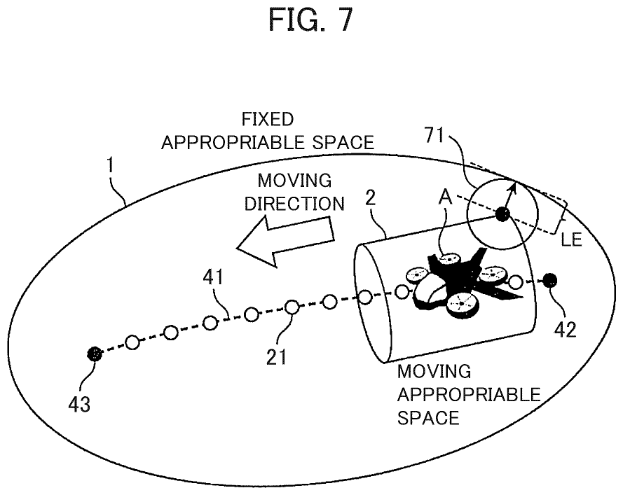

Next, the relation between the fixed appropriable space 1 and the moving appropriable space 2 will be explained using FIG. 7.

FIG. 7 is a drawing explaining the relation between the fixed appropriable space 1 and the moving appropriable space 2.

When the center of gravity of the craft A is located on the partial 4D route 41, the relation between the fixed appropriable space 1 and the moving appropriable space 2 is deemed to be such relation that the fixed appropriable space 1 includes entire moving appropriable space 2. In concrete terms, the fixed appropriable space 1 and the moving appropriable space 2 are deemed to be the closure, and the relation between the fixed appropriable space 1 and the moving appropriable space 2 is defined as described below.

Definition (d3): All points on the boundary surface (surface) defining the moving appropriable space 2 are interior points of the fixed appropriable space 1.

Definition (d4): The surface of the sphere (closed sphere) having the radius LE>0, the center of gravity of the sphere being an optional point on the boundary surface (surface) defining the moving appropriable space 2, contacts the boundary surface of the fixed appropriable space 1 at one point or more.

According to the definitions (d3) and (d4), when the radius LE of a sphere 71 on the boundary surface of the moving appropriable space 2 illustrated in FIG. 7 becomes zero, it is determined that the boundary surface of the fixed appropriable space 1 and the boundary surface of the moving appropriable space 2 contact (namely interfere). When the definition (d3) is not fulfilled, it is determined that the fixed appropriable space 1 does not include entire moving appropriable space 2, and the moving appropriable space 2 has a portion (space) not overlapping with the fixed appropriable space 1.

According to the definitions (d3) and (d4), the fixed appropriable space 1 is a space including the moving appropriable space 2 so that the radius of the sphere becomes LE>0 when the center of gravity of the craft A is located on the partial 4D route 41. That is to say, when the center of gravity of the craft A is located on the partial 4D route 41, entire moving appropriable space 2 is to be positioned inside the fixed appropriable space 1 without an event that the boundary surface of the fixed appropriable space 1 and the boundary surface of the moving appropriable space 2 contact. According to the definition of LE, LE is simply the distance between the boundary surface of the fixed appropriable space 1 and the boundary surface of the moving appropriable space 2. However, to be exact, LE is defined at all positions on the boundary surface of the moving appropriable space 2. Therefore, it is to be noted that the distance between the boundary surface of the fixed appropriable space 1 and the boundary surface of the moving appropriable space 2 is to be specified as a set of LE. That is to say, the distance between the boundary surface of the fixed appropriable space 1 and the boundary surface of the moving appropriable space 2 is specified by set {LE(si)>0|si⊂Si}.

The positional relation between the fixed appropriable space 1 and the partial 4D route 41 is to be restricted and determined indirectly as illustrated in FIG. 7 by way of an event that, when the center of gravity of the craft A is located on the partial 4D route 41, the fixed appropriable space 1 is in the relation of including the moving appropriable space 2 without an event that the boundary surface of the fixed appropriable space 1 and the boundary surface of the moving appropriable space 2 contact.

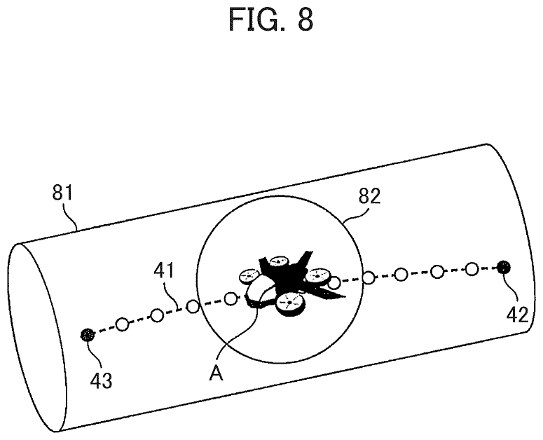

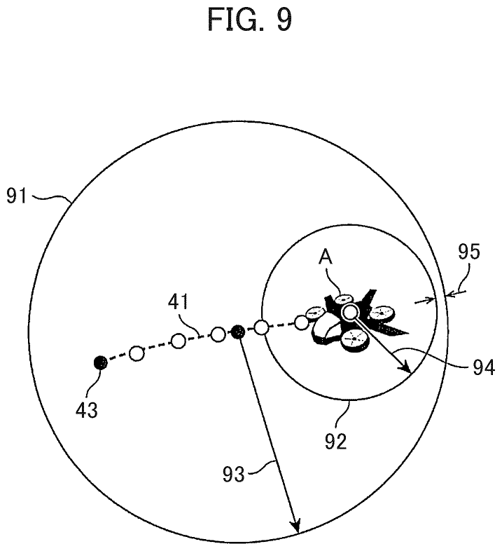

According to such relation of the fixed appropriable space 1, the moving appropriable space 2, and the 4D route 4 as described above, the shape of the fixed appropriable space 1 and the moving appropriable space 2 is not particularly limited as exemplified in FIG. 8 and FIG. 9.

FIG. 8 is a drawing illustrating an example where the fixed appropriable space 1 is of a cylindrical shape 81, and the moving appropriable space 2 is of a spherical shape 82. FIG. 9 is a drawing illustrating an example where the fixed appropriable space 1 is of a spherical shape 91, and the moving appropriable space 2 is of a spherical shape 92.

That is to say, each shape of the fixed appropriable space 1 and the moving appropriable space 2 may be a shape forming a convex space such as a sphere, cube, or rectangular parallelepiped, and may be a shape forming a non-convex space. In other words, each shape of the fixed appropriable space 1 and the moving appropriable space 2 may be any three-dimensional shape capable of forming a three-dimensional space.

FIG. 9 illustrates a simple example where both of the fixed appropriable space 1 and the moving appropriable space 2 are of a spherical shape. In an example of FIG. 9, the distance LM between the boundary surface of the moving appropriable space 92 and the center of gravity of the craft A is simply a radius 94. The distance LE between the fixed appropriable space 91 and the moving appropriable space 92 can be represented by a minimum distance 95 (when LE is deemed to be a set, the minimum distance 95 is MIN{LE}). Also, assuming that the center of the spherical body of the fixed appropriable space 91 is positioned on the partial 4D route 41, the positional relation between the fixed appropriable space 91 and the partial 4D route 41 can be simplified. Thus, since the operation management system 6 can reduce the calculation amount in designing the fixed appropriable space 1 and the moving appropriable space 2, the calculation amount in planning the 4D route 4 can be reduced.

Based on the fixed appropriable space 1 and the partial 4D route 41 defined as described above, the 4D route planning unit 8 forms the 4D route 4, 4b of each craft A, B through connection of the fixed appropriable space 1, 1b namely though the time series of the fixed appropriable space 1, 1b. The 4D route planning unit 8 can plan such 4D route 4, 4b that the fixed appropriable space 1, 1b of each craft A, B does not overlap with each other at all clock times of the operation plan. Therefore, the 4D route planning unit 8 can plan the safe 4D route 4, 4b eliminating the collision risk (inclusive of the abnormal near miss risk) of each craft A, B and provide each craft A, B with the same.

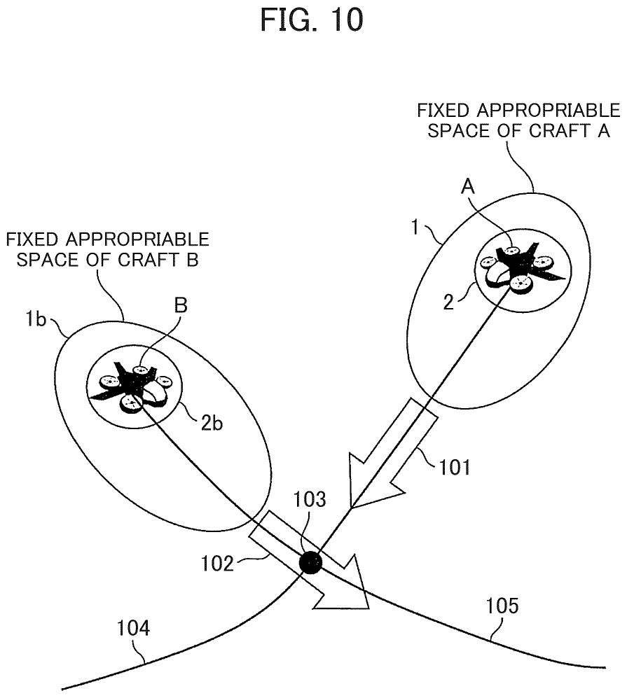

In addition, as explained using FIG. 10, the 4D route planning unit 8 can plan the 4D route 4, 4b with excellent spatial efficiency.

FIG. 10 is a drawing illustrating a case where orbits 104, 105 of the 4D routes 4, 4b of respective crafts A, B cross each other.

The orbit 104 of the 4D route 4 is a line connecting the three-dimensional coordinate of each four-dimensional vector 21 configuring the 4D route 4 in the order of the clock time. The orbit 104 of the 4D route 4 is configured as a series of the three-dimensional vector excluding the clock time of each four-dimensional vector 21. The orbit 104 of the 4D route 4 extends along a moving direction 101 of the craft A. The orbit 105 of the 4D route 4b is a line connecting the three-dimensional coordinate of each four-dimensional vector configuring the 4D route 4b in the order of the clock time, and extends along a moving direction 102 of the craft B.

In FIG. 10, the orbit 104 of the 4D route 4 of the craft A and the orbit 105 of the 4D route 4b of the craft B cross at an intersection point 103. Even in this case, since the 4D route planning unit 8 designs the 4D route 4, 4b as a time series of the fixed appropriable space 1, 1b, it is possible to plan such 4D route 4, 4b that one of respective crafts A, B does not enter the fixed appropriable space of the other at all clock times. That is to say, the 4D route planning unit 8 only has to plan the 4D route 4, 4b of each craft A, B as a time series of the fixed appropriable space 1, 1b so that the craft A passes through the intersection point 103 after the craft B passes through the intersection point 103 and becomes sufficiently apart from the intersection point 103. For example, the 4D route planning unit 8 plans the 4D route 4, 4b so that the fixed appropriable space 1 of the craft A at a clock time when the craft A passes through the intersection point 103 does not overlap with the fixed appropriable space 1b of the craft B at the clock time in question. Thus, the 4D route planning unit 8 can design the safe 4D route 4, 4b without the collision risk of each craft A, B while allowing crossing of the orbits 104, 105 of the 4D routes 4, 4b. Therefore, the 4D route planning unit 8 can plan the 4D routes 4, 4b with better spatial efficiency compared to a method of a prior art of designing a route so that the orbits 104, 105 do not cross.

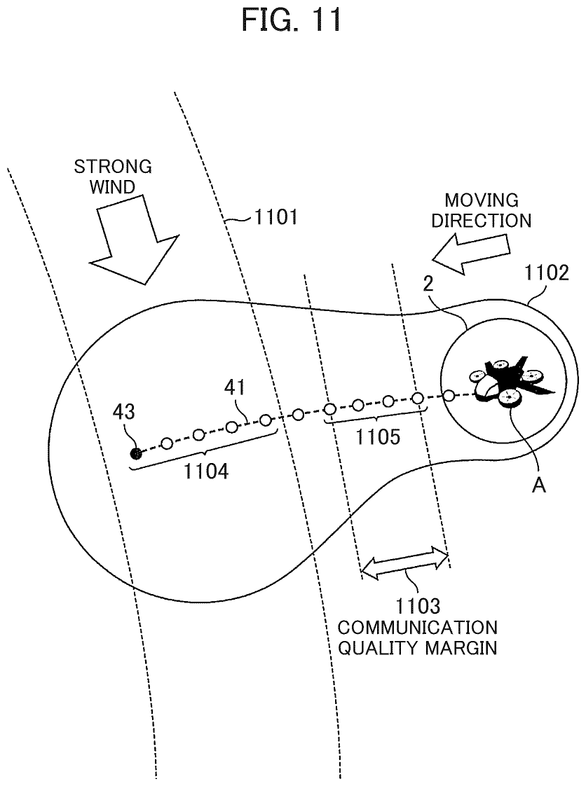

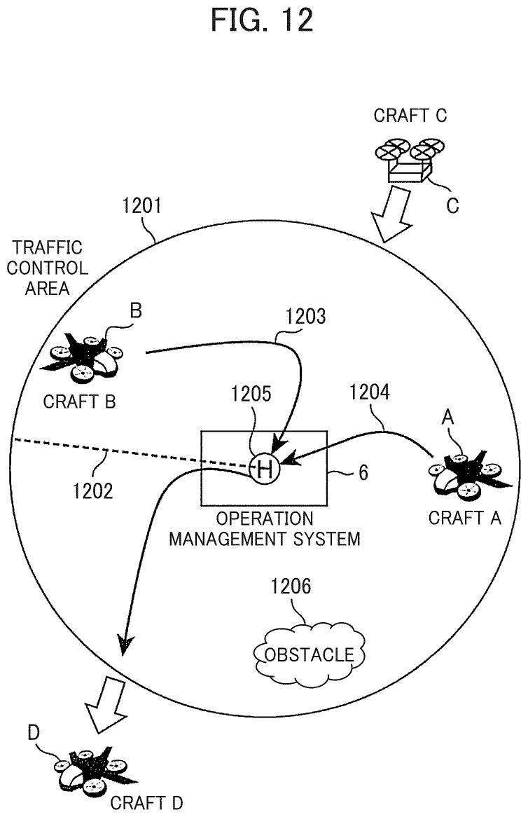

Next, the design concept of the fixed appropriable space 1, 1b designed by the fixed appropriable space designing unit 13 will be explained using FIG. 11 and FIG. 12.

FIG. 11 is a drawing explaining a design concept of the fixed appropriable space 1, 1b. FIG. 12 is a drawing explaining a management area 1201 managed by the operation management system 6.

In FIG. 11, it is assumed that the size (volume) and the shape of the moving appropriable space 2 do not change even when the craft A is entirely included in the moving appropriable space 2 having a spherical shape, moves on the partial 4D route 41, and is located at any position on the partial 4D route 41. In FIG. 11, a fixed appropriable space 1102 includes a partial 4D route 41. The fixed appropriable space 1102 includes the moving appropriable space 2 of the craft A even when the craft A is located at any position on the partial 4D route 41.

The size and shape of the fixed appropriable space 1102 illustrated in FIG. 11 is made as a size and shape considering the wind state and the communication quality. The communication quality is the quality of communication between the communication device 17 of the operation management system 6 and the craft A. In each spot within the management area, there is a case that the wind state and easiness of propagation of the radio wave differ. Therefore, the fixed appropriable space designing unit 13 designs the size and shape of the fixed appropriable space 1102 considering the wind state and the communication quality.

In FIG. 11, a point group 1104 on the partial 4D route 41 exists within a strong wind area 1101. This means that, at the three-dimensional coordinate and the clock time shown by the point group 1104, the partial 4D route 41 is located within the strong wind area 1101. Therefore, it means that, when the craft A passes through the point group 1104, the craft A is located within the strong wind area 1101 and is exposed to strong wind. At this time, the craft A has a risk of deviating from the partial 4D route 41 according to the circumstances. Even in such case, in order that the moving appropriable space 2 is included in the fixed appropriable space 1102, the fixed appropriable space designing unit 13 designs the fixed appropriable space 1102 into a shape where the size of the fixed appropriable space 1102 around the point group 1104 is enlarged. Thus, even when the craft A may deviate from the partial 4D route 41 around the point group 1104, the moving appropriable space 2 is included in the fixed appropriable space 1102, and therefore it is enabled to design safe 4D route 4 without the collision risk against other crafts.

Also, in FIG. 11, such case is assumed that communication between the craft A and the operation management system 6 is interrupted when the craft A passes through a point group 1105. In this case, the fixed appropriable space designing unit 13 enlarges the size of the fixed appropriable space 1102 along the moving direction of the craft A, and designs the fixed appropriable space 1102 into a shape of arranging a communication quality margin 1103. Therefore, even when communication interruption may occur around the point group 1105, the craft A flies on the partial 4D route 41, and thereby the moving appropriable space 2 can be included in the fixed appropriable space 1102. This fact means that planning of safe 4D route 4 without the collision risk against other crafts is possible by that the craft A flies on the partial 4D route 41 even when communication interruption may occur.

Also, deviation of the craft A from the partial 4D route 41 (namely deviation from the 4D route 4) includes temporal delay/advance. That is to say, a case that arrival of the craft A at a certain point (three-dimensional coordinate and clock time) on the partial 4D route 41 is delayed from a designed clock time and a case that arrival is earlier than a designed clock time are also deviation from the partial 4D route 41. Reservation of a margin by enlarging the shape of the fixed appropriable space 1102 along the moving direction as the communication quality margin 1103 fulfills a role of allowing temporal delay/advance of the craft A in a cause other than the communication interruption. Therefore, according to such reservation of a margin, even when the craft A may cause temporal delay/advance with respect to the partial 4D route 41 due to some cause, the moving appropriable space 2 is included in the fixed appropriable space 1102, and therefore it is enabled to plan safe 4D route 4 without the collision risk against other crafts.

In FIG. 12, it is assumed that the management area 1201 is given with a radius 1202. Here, a body whose existence is grasped by the operation management system 6 is defined to be a managed body. A body whose existence is not grasped by the operation management system 6 is defined to be a non-managed body. It is not realistic, in planning the 4D routes 4, 4b of plural crafts A, B, that the operation management system 6 grasps all obstacles 1206 (birds or compact drones and the like for example) with various sizes within the management area 1201 becoming a hamper of flight. That is to say, a non-managed body becoming a hamper of flight possibly exists within the management area 1201.

The fixed appropriable space designing unit 13 designs the fixed appropriable space 1, 1b so that each boundary surface of the fixed appropriable space 1, 1b and each boundary surface of the moving appropriable space 2, 2b do not contact (interfere) respectively even when each of the craft A and the craft B detects a non-managed body and goes around the non-managed body by own determination to deviate from the route. That is to say, by connecting the fixed appropriable spaces 1, 1b designed thus and planning the 4D routes 4, 4b, the operation management system 6 can plan the 4D routes 4, 4b that allow the degree of freedom of capability of going around a non-managed body possibly existing within the management area 1201 by own determination of each craft A, B. In an example of FIG. 3, in order to go around an obstacle 31 that is a non-managed body, the craft A can plan a route 32 for deviating from the 4D route 4 by determination of the craft A itself. This route 32 is planned depending on the performance of detection of the non-managed body by the craft A and the kinematic performance of the craft A. Therefore, the fixed appropriable space designing unit 13 designs the fixed appropriable spaces 1, 1b considering the performance of detection of the non-managed body in each craft A, B and the kinematic performance of each craft A, B. Thus, the operation management system 6 can plan the 4D routes 4, 4b in which it is considered that a non-managed body possibly exists within the management area 1201.

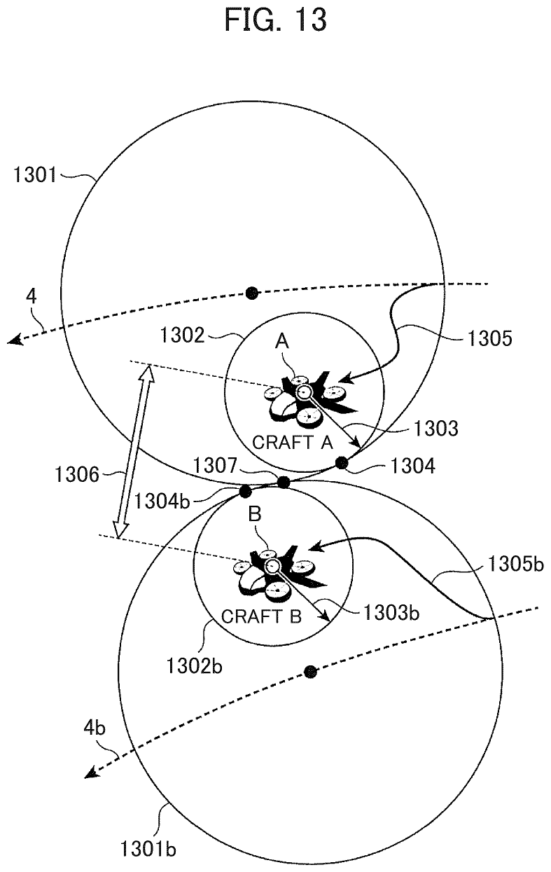

Next, a design concept of the moving appropriable space 2, 2b designed by the moving appropriable space designing unit 14 will be explained using FIG. 13.

FIG. 13 is a drawing explaining the design concept of the moving appropriable space 2, 2b.

FIG. 13 illustrates a case where the fixed appropriable space 1, 1b and the moving appropriable space 2, 2b of each craft A, B are formed into a spherical body respectively as illustrated in FIG. 9. The 4D route planning unit 8 plans the 4D routes 4, 4b so that the fixed appropriable spaces 1, 1b of respective crafts A, B do not overlap with each other, and can thereby plan the 4D routes 4, 4b with excellent spatial efficiency as illustrated in FIG. 10. Therefore, the 4D route planning unit 8 can plan such 4D routes 4, 4b that the boundary surfaces of the fixed appropriable space 1, 1b of respective crafts A, B contact each other as illustrated in FIG. 13.

In FIG. 13, the 4D routes 4, 4b are designed so that the boundary surface of a fixed appropriable space 1301 of the craft A and the boundary surface of a fixed appropriable space 1301b of the craft B contact at a contact point 1307. A radius 1303 of a moving appropriable space 1302 of the craft A is made RaA, and a radius 1303b of a moving appropriable space 1302b of the craft B is made RaB. Also, FIG. 13 illustrates an example where the craft A and the craft B respectively deviate from the 4D route 4 and the 4D route 4b provided by the operation management system 6 due to various phenomena and fly on routes 1305, 1305b. FIG. 13 illustrates an example where the boundary surface of the moving appropriable space 1302 of the craft A contacts the boundary surface of the fixed appropriable space 1301 at a contact point 1304, and the boundary surface of the moving appropriable space 1302b of the craft B contacts the boundary surface of the fixed appropriable space 1301b at a contact point 1304b.

Even in such case, when the moving appropriable space 1302, 1302b of each craft A, B is included in own fixed appropriable space 1301, 1301b, there is no event that the distance between both crafts 1306 becomes equal to or less than (RaA+RaB). That is to say, when the fixed appropriable spaces 1301, 1301b of respective crafts A, B do not overlap with each other and the moving appropriable space 1302, 1302b of each craft A, B is included in own fixed appropriable space 1301, 1301b, the moving appropriable space 1302, 1302b arranged in each craft A, B becomes a safety margin for avoiding the collision against other crafts. This safety margin is given simply by RaA+RaB in the case of FIG. 13. RaA+RaB possibly corresponds to the proximity permission distance described above. Therefore, even when each craft A, B deviates from the 4D route 4, 4b due to various phenomena, the 4D route planning unit 8 planning the 4D route 4, 4b based on the fixed appropriable space 1301, 1301b including such moving appropriable space 1302, 1302b can plan the safe 4D route 4, 4b without the risk of collision of the craft A and the craft B.

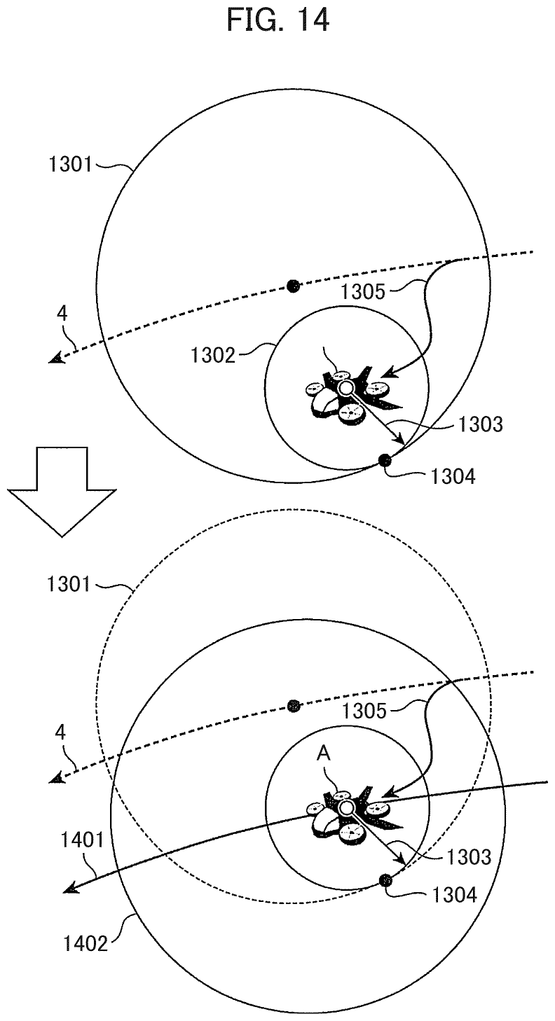

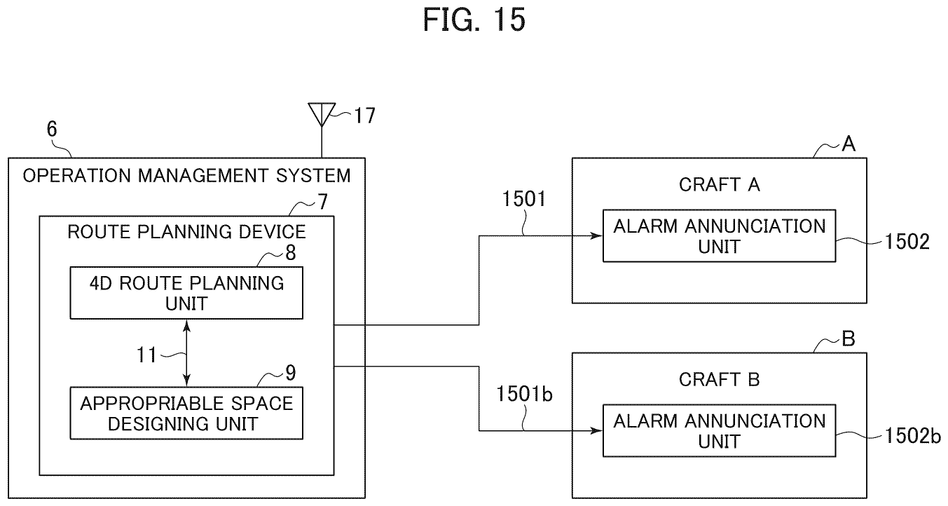

Next, the re-planning function for the 4D route 4, 4b will be explained using FIG. 14 and FIG. 15. The route planning device 7 executes re-planning of the 4D route 4, 4b modifying the fixed appropriable space 1, 1b so that the 4D route 4, 4b can be planned more flexibly, on a real-time basis, and dynamically.

FIG. 14 is a drawing explaining a re-planning function for the 4D route 4, 4b. FIG. 15 is a block diagram explaining an alarm issuance function of the route planning device 7.

In FIG. 14, in order to avoid such situation that the moving appropriable space 1302 of the craft A comes to be not included in the fixed appropriable space 1301, the route planning device 7 modifies the fixed appropriable space 1301 as described below, and re-plans the 4D route 4. That is to say, when the boundary surface of the moving appropriable space 1302 of the craft A contacts (interferes with) the boundary surface of the fixed appropriable space 1301, the fixed appropriable space designing unit 13 modifies the fixed appropriable space 1301 of the craft A as a fixed appropriable space 1402 so that contact (interference) of the boundary surface of the both parties is resolved. Also, the 4D route planning unit 8 newly re-plans a 4D route 1401 according to the fixed appropriable space 1402 having been modified. Thus, even when the craft A may deviate from the 4D route 4 due to various phenomena, such event can be possibly avoided that the moving appropriable space 1302 comes not to be included in the fixed appropriable space 1301. Therefore, if such re-planning can be executed, even when each craft A, B may deviate from the 4D route 4, 4b due to various phenomena, the 4D route planning unit 8 can plan the safe 4D route 4, 4b without the risk of collision of the craft A and the craft B.

Also, with respect to the re-planning function for the 4D route 4, 4b, the fixed appropriable space designing unit 13 can modify the fixed appropriable space of not only a craft of the object of re-planning but also of other surrounding crafts. Also, the 4D route planning unit 8 can re-plan the 4D route of other crafts according to the fixed appropriable space of other crafts having been modified. Thus, the route planning device 7 can re-plan the 4D route of other crafts even under a state of proximity to another craft to such degree that modification of the fixed appropriable space of own craft is difficult, and therefore a 4D route that is safe and with excellent spatial efficiency can be planned with respect to the 4D route of all crafts under management.

Whether or not such re-planning is to be executed is determined by the space interference determination unit 15 of FIG. 1. The space interference determination unit 15 acquires information of each size and each shape of the fixed appropriable space 1, 1b and the moving appropriable space 2, 2b of each craft A, B from the fixed appropriable space designing unit 13 and the moving appropriable space designing unit 14. The space interference determination unit 15 determines whether or not both of the boundary surface of the fixed appropriable space 1 and the boundary surface of the moving appropriable space 2 of the craft A contact (interfere) based on the positional information 5 of the craft A. The space interference determination unit 15 determines whether or not both of the boundary surface of the fixed appropriable space 1b and the boundary surface of the moving appropriable space 2b of the craft B contact based on the positional information 5b of the craft B.

When it is determined that the both contact in each craft A, B, the space interference determination unit 15 instructs the fixed appropriable space designing unit 13 to modify the fixed appropriable space 1, 1b, and instructs the 4D route planning unit 8 to re-plan the 4D route 4, 4b. In receiving the instruction from the space interference determination unit 15, the fixed appropriable space designing unit 13 and the 4D route planning unit 8 modify the fixed appropriable space 1, 1b and re-plans the 4D route 4, 4b.

Also, with respect to determination of contact of the boundary surface described above, it is to be noted that there is such case that the moving appropriable space 2, 2b does not have to be defined to be one accompanying movement of the center of gravity of each craft A, B only when the moving appropriable space 2, 2b has a predetermined shape. For example, when both of the fixed appropriable space 91 and the moving appropriable space 92 are of a spherical shape and the shape is constant with respect to rotation as illustrated in FIG. 9, a spherical body (space) having a radius of (radius 93-radius 94) not accompanying such movement of the craft A to make the center of gravity of the craft A same to the center of gravity of the fixed appropriable space 91 is defined, and determination of contact of the boundary surface of the moving appropriable space 92 similarly to one accompanying movement of the center of gravity of the craft A is possible by whether or not the center of gravity of the craft A flying inside this spherical body contacts the boundary surface of the spherical body. Thus, the moving appropriable space 2, 2b is a generalized superordinate concept not restricted by the shape of its space.

The re-planning function for the 4D route 4, 4b provides an advantage of making the size of the fixed appropriable space 1, 1b economical and compact. The reason is that, when re-planning is not allowed, the size of the fixed appropriable space 1, 1b has to be made large from the initial stage of planning of the 4D route 4, 4b. Therefore, the re-planning function for the 4D route 4, 4b can contribute to the point that the 4D route 4, 4b with excellent spatial efficiency can be planned.

However, it does not mean that re-planning of the 4D route 4, 4b can be executed always. FIG. 13 is an example of a state where re-planning as illustrated in FIG. 14 is difficult. In view of such circumstances, the route planning device 7 has an alarm issuance function of transmitting an alarm 1501, 1501b to each craft A, B to fly along the 4D route 4, 4b as illustrated in FIG. 15. An alarm annunciation unit 1502, 1502b of each craft A, B announces the alarm 1501, 1501b, and promotes returning to the 4D route 4, 4b. Thus, each craft A, B can fly along the 4D route 4, 4b provided by the operation management system 6 in spite of keeping the degree of freedom of deviation from the 4D route 4, 4b.

The space interference determination unit 15 transmits the alarm 1501, 1501b to each craft A, B when the both of the boundary surface of the fixed appropriable space 1, 1b and the boundary surface of the moving appropriable space 2, 2b are determined to contact and the 4D route 4, 4b cannot be re-planned (the fixed appropriable space 1, 1b cannot be modified so as to resolve interference of the both). Determination of whether or not re-planning of the 4D route 4, 4b can be executed (possibility determination) is executed based on the positional information 5, 5b of each craft A, B and information of each size and each shape of the fixed appropriable space 1, 1b and the moving appropriable space 2, 2b. This possibility determination of re-planning is executed employing the adjacency state of the fixed appropriable space 1, 1b and the deviation amount from the 4D route 4, 4b of each craft A, B for example as the criteria for determination as illustrated in FIG. 13.

In planning the 4D route 4, 4b, the 4D route planning unit 8 requires information of the fixed appropriable space 1, 1b. The reason is that the 4D route 4, 4b is configured by connection of the partial 4D routes included in the fixed appropriable space 1, 1b, and is designed as a time series of the fixed appropriable space 1, 1b as a result. Also, the fixed appropriable space 1, 1b includes the moving appropriable space 2, 2b. Further, the size and shape of the fixed appropriable space 1, 1b depend on the size and shape of the moving appropriable space 2, 2b. Therefore, in planning the 4D route 4, 4b, it is required for the 4D route planning unit 8 to acquire information of the fixed appropriable space 1, 1b and the moving appropriable space 2, 2b from the fixed appropriable space designing unit 13 and the moving appropriable space designing unit 14.

Although it is preferable that the fixed appropriable space 1, 1b can be designed to be largest possible, when the size of the fixed appropriable space is designed to be extremely large, the spatial efficiency is sacrificed which results in drop of the operation efficiency. The operation efficiency is made a scalar value expressing the number of times of takeoff and landing can be executed per a unit time with respect to a predetermined area (plural areas may be exist) for one craft on the ground serviceable for takeoff and landing. If payment of a user may occur by the number of times of takeoff and landing, with respect to the operation management system 6, improvement of the operation efficiency is required from the viewpoint of business. That is to say, with respect to the 4D route 4, 4b, excellent spatial efficiency is required.

The size and shape of the moving appropriable space 2, 2b are determined according to assumed uncertainty because of the role of the moving appropriable space 2, 2b. As uncertainty related to operation of each craft A, B, there can be cited problems of a position measurement error of each craft A, B, quality of communication with each craft A, B, and an error of tracking the 4D route 4, 4b. The problem of the position measurement error is such problem that an error caused in measuring the position of each craft A, B is enlarged, and that reliability (36 or 66, and the like) in position measurement deteriorates. The problem of communication quality is such problem that communication between each craft A, B and the operation management system 6 is delayed or interrupted. The problem of the error of tracking the 4D route 4, 4b is a problem depending on the performance of each craft A, B itself and the external environment such as the wind state. The moving appropriable space 2, 2b is designed so that each craft A, B can secure a safe distance eliminating the risk of collision against other crafts even when such uncertainty may exist. Also, in a similar manner, the fixed appropriable space 1, 1b is also designed so that safe 4D route 4, 4b without the risk of collision against other crafts even when such uncertainty may exist can be planned.

The wind state prediction device 10 of FIG. 1 predicts the wind state of each spot within the management area 1201 until a predetermined time in future, and provides the appropriable space designing unit 9 with the wind state information 12 from time to time. Accuracy of tracking the 4D route 4, 4b depending on the external environment such as the wind state depends on the wind state of each spot and the clock time of passing through the spot. Therefore, in order that the moving appropriable space designing unit 14 designs the moving appropriable space 2, 2b considering accuracy of tracking the 4D route 4, 4b based on the wind state information 12, it is required that the 4D route 4, 4b or the partial 4D route is to be given. Also, in order that the fixed appropriable space designing unit 13 designs the fixed appropriable space 1, 1b considering accuracy of tracking the 4D route 4, 4b, it is required that the 4D route 4, 4b or the partial 4D route is to be given. Also, it is assumed that the communication quality may possibly be dispersed depending on each spot within the management area 1201. From such viewpoints, in order that the fixed appropriable space designing unit 13 designs the fixed appropriable space 1, 1b considering the communication quality, it is required that the 4D route 4, 4b or the partial 4D route is to be given.

Therefore, the route planning device 7 of FIG. 1 repeatingly executes designing of the fixed appropriable space 1, 1b and the moving appropriable space 2, 2b and planning of the 4D route 4, 4b while sharing required information by the 4D route planning unit 8 and the appropriable space designing unit 9. Thus, the route planning device 7 can plan the 4D route 4, 4b that is safe and with excellent spatial efficiency, and can provide each craft A, B with the same.

Re-planning of the 4D route 4, 4b is not limited to be executed when instruction from the space interference determination unit 15 is received. As illustrated in FIG. 12, re-planning of the 4D route 4, 4b can be possibly executed when new craft C enters into the management area 1201, and when a craft D within the management area 1201 retracts to outside the management area 1201. Also, determination of whether or not re-planning of the 4D route 4, 4b is required to be executed (necessity determination) may be executed periodically at a predetermined frequency. That is to say, it is also possible that the route planning device 7 acquires the positional information 5, 5b of the 4D route 4, 4b at a predetermined frequency until each craft A, B reaches the finish point from the start point of the 4D route 4, 4b, and determines, every time the positional information 5, 5b is required, whether or not re-planning of the 4D route 4, 4b is required. Thus, the route planning device 7 can easily plan the 4D route 4, 4b that is safe and with excellent spatial efficiency on a real-time basis and dynamically, and can constantly provide each craft A, B with optimal 4D route 4, 4b. Also, when each craft A, B is flying along the 4D route 4, 4b having been already provided, it is not required to execute re-planning of the 4D route 4, 4b highly frequently.

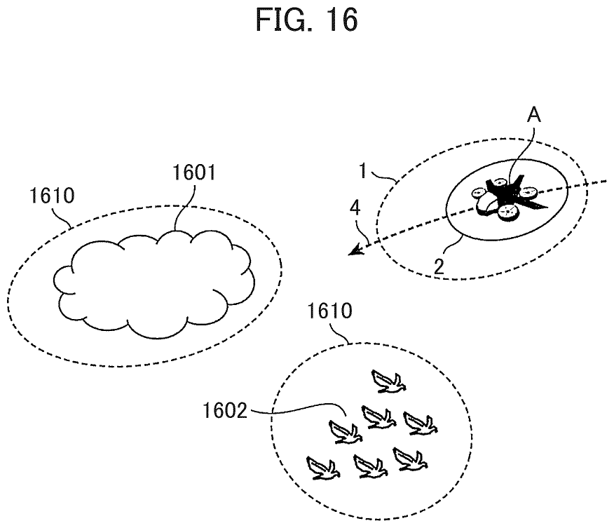

Next, an appropriable space 1610 designed for a managed body will be explained using FIG. 16 to FIG. 19.

FIG. 16 to FIG. 19 are drawings illustrating an example of the appropriable space 1610 designed for a managed body.

Although planning of safe 4D route 4, 4b considering the risk of collision against other crafts and the risk of collision against a non-managed body has been explained so far, the route planning device 7 can plan safe 4D route 4, 4b considering the risk of collision against the managed body. In concrete terms, the appropriable space designing unit 9 designs the appropriable space 1610 not permitting entering of each craft A, B with respect to a managed body becoming a hamper of flight of each craft A, B. The fixed appropriable space 1, 1b of each craft A, B and the appropriable space 1610 designed for each managed body are designed so as not to overlap with each other at all clock times.

As the managed body, there can be cited, for example, a meteorological area 1601 becoming a hamper of the flight such as an area where the crowd obstructing visibility of each craft A, B exists and a flying body 1602 such as a group of birds as illustrating in FIG. 16. In FIG. 16, the appropriable space designing unit 9 designs the appropriable space 1610 with respect to each of the meteorological area 1601 and the flying body 1602. Thus, the 4D route planning unit 8 can plan the 4D route 4, 4b considering route deviation by the meteorological area 1601 and the risk of collision against the flying body 1602. Also, it is to be noted that discrimination of a managed body and a non-managed body depends on the performance of an observation device of the operation management system 6 observing them and grasping existence of them.

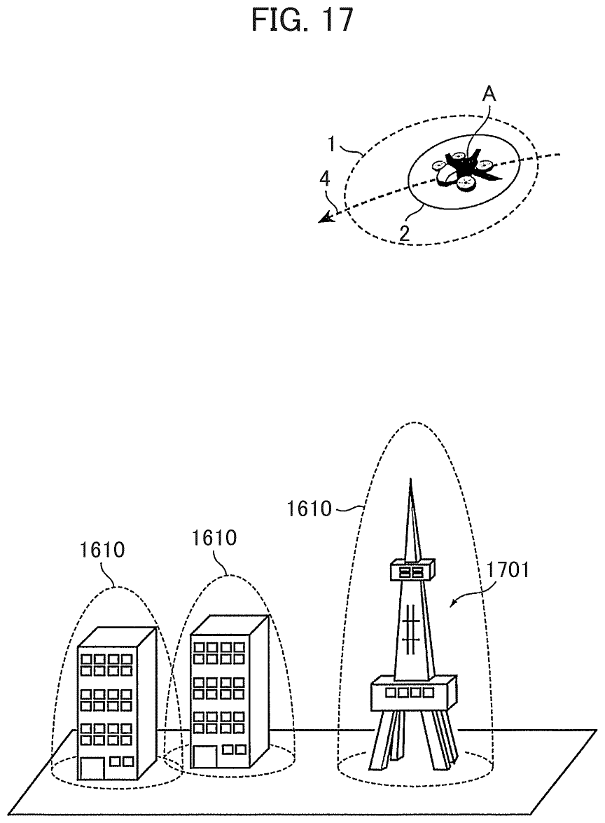

Also, as the managed body, there can be cited, for example, an aboveground structure 1701 becoming a hamper of flight of each craft A, B such as a broadcasting tower and a high-rise building as illustrated in FIG. 17. In FIG. 17, the appropriable space designing unit 9 designs the appropriable space 1610 with respect to the aboveground structure 1701. Thus, the 4D route planning unit 8 can plan the 4D route 4, 4b considering the risk of collision against the aboveground structure 1701.

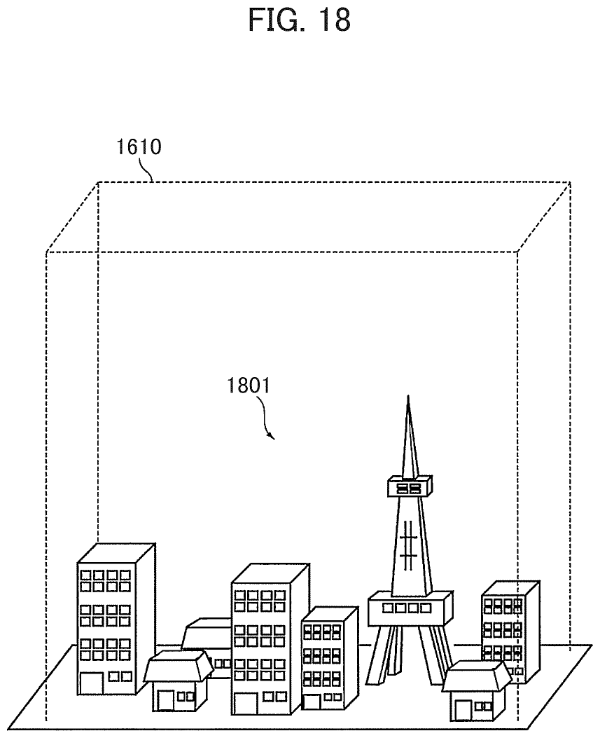

Also, as the managed body, there can be cited, for example, an air exclusion area 1801 such as an airspace above important facilities such as a nuclear power station and a densely populated area of a residential area and the like as illustrated in FIG. 18. In FIG. 18, the appropriable space designing unit 9 designs the appropriable space 1610 with respect to the air exclusion area 1801. Thus, the 4D route planning unit 8 can plan the 4D route 4, 4b considering avoidance of entering to the air exclusion area 1801. Damage by crashing to the air exclusion area 1801 and noise damage can be possibly avoided.

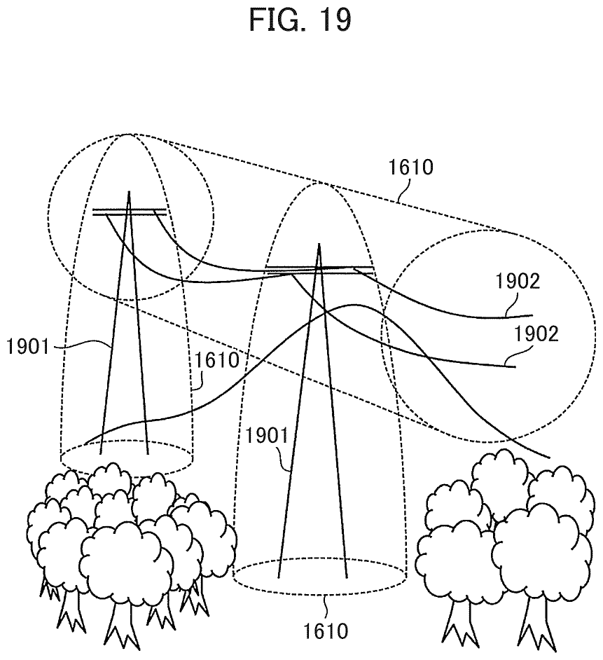

Also, as the managed body, there can be cited, for example, a steel tower 1901 and an electric wire 1902 present in a mountain area as illustrated in FIG. 19. In FIG. 19, the appropriable space designing unit 9 designs the appropriable space 1610 with respect to each of the steel tower 1901 and the electric wire 1902. That is to say, the appropriable space designing unit 9 can design the appropriable space 1610 also with respect to a managed body stretching in the air space such as the electric wire 1902. Thus, the 4D route planning unit 8 can plan the 4D route 4, 4b considering the risk of collision against the steel tower 1901 and the electric wire 1902.

As explained so far, the operation management system 6 can automatically plan safe 4D route with excellent spatial efficiency without the risk of collision against other crafts under management and a managed body on a real-time basis and dynamically. Also, the operation management system 6 can plan the 4D route having high robustness permitting route deviation caused by going around a non-managed body by determination of each craft itself, route deviation caused by external environment such as the wind state, route deviation caused by position measurement error and the like, and so on.

Also, an operation management system possibly applied to a takeoff and landing place of an aircraft such as the operation management system 6 is required to assume flight of a fixed-wing aircraft within the management area as a realistic problem even when the aircraft of the management object is limited to a vertical takeoff and landing aircraft. The reason is that such case is assumed that a fixed wing aircraft passes through the inside of a management area of the operation management system. When a vertical takeoff and landing aircraft and a fixed-wing aircraft are under management, as a problem peculiar to an aircraft, it does not mean that a 4D route can be planned with a premise that these crafts stand by or stop flight at the spot. That is to say, in both of the stage of initial route planning and the stage of re-planning thereafter, it is important to plan a 4D route assuming a time period until a medium- to long-term clock time when stand by or flight stop of the craft at the spot is not selected as much as possible.

Since the operation management system 6 can plan a 4D route of a medium- to long-term capable of achieving a flight object of a craft flying from the start point to the finish point by connection of the fixed appropriable spaces, the operation management system 6 can automatically plan a 4D route not selecting stand by or flight stop of the craft at the spot as much as possible on a real time basis and dynamically even when a fixed-wing aircraft that cannot stand by at the spot is under management.

Also, the operation management system 6 is not one dividing the management area of the operation management system 6 into plural areas to manage permission/forbiddance of flight in each area as Patent Literature 1. The operation management system 6 can easily plan a sophisticated 4D route where determination of permission/forbiddance of flight does not become discrete in each divided area, and where such problem that handling at a boundary surface of the discretely divided areas becomes difficult does not occur.

Also, when designing of the fixed appropriable space and the moving appropriable space and planning of the 4D route are to be repeatedly executed, the operation management system 6 may plan the 4D route so as to arrange a predetermined evaluation item or a predetermined restriction and to fulfill them. For example, from the viewpoint of improving the operation efficiency, the operation management system 6 may arrange a reduction amount of the route length of the 4D route or a reduction amount of the moving time from the start point to the finish point, and so on as a predetermined evaluation item. Also, for example, from the viewpoint of the ride comfort of the craft, the operation management system 6 may arrange to make the curvature of the 4D route equal to or less than a predetermined value, and so on as a predetermined restriction.

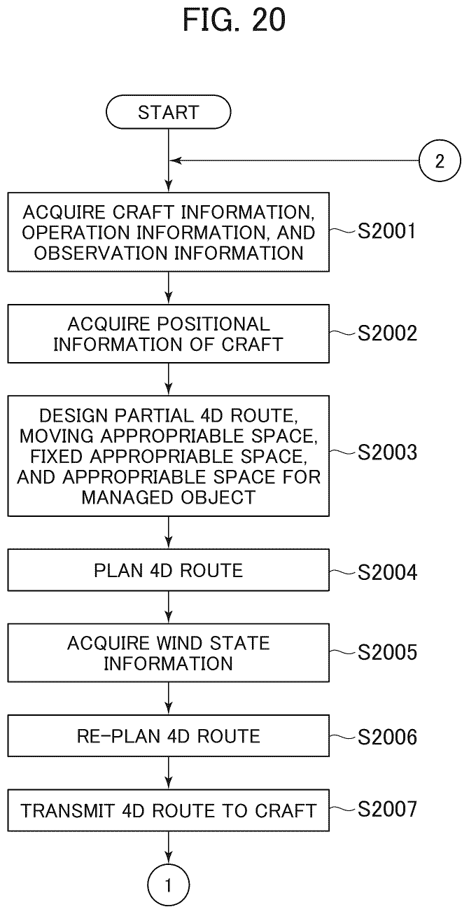

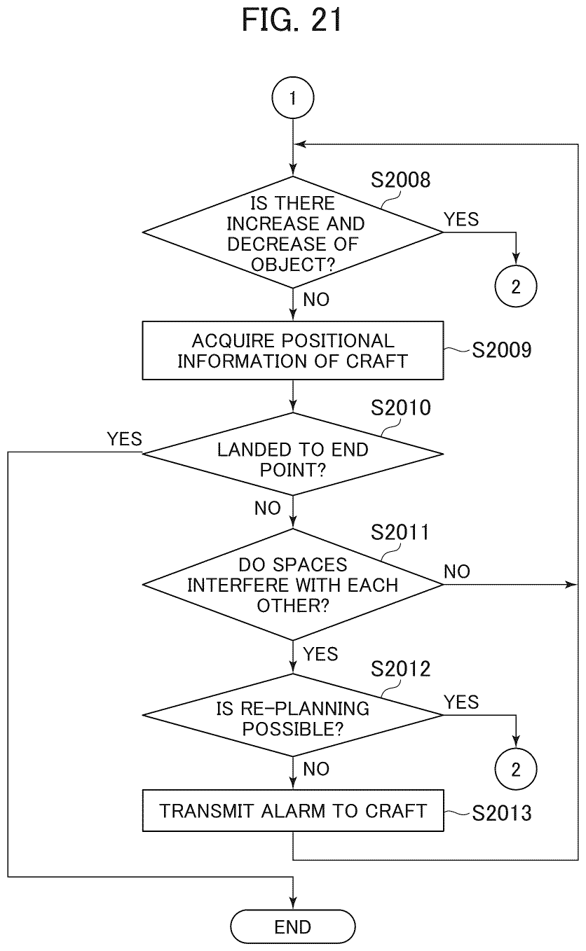

Next, a flow of the process executed by the operation management system 6 will be explained using FIG. 20 and FIG. 21.

FIG. 20 is a flowchart of the process executed by the operation management system 6. FIG. 21 is a flowchart of the process executed consecutively to FIG. 20.

In step S2001, the operation management system 6 acquires craft information of each craft under management, operation information of each craft, and observation information of a management area and a managed body. The craft information includes information of the dimension and the performance (inclusive of the detection performance and the kinetic performance of a non-managed body) of the craft, information of position measurement performance (position measurement error), and so on. The operation information includes information of the start point, the transit point, and the finish point of each craft (inclusive of the clock time of passage), and so on. The observation information includes information of the position, the size, and the like of the managed body and information of the quality of communication with other crafts.

In step S2002, the operation management system 6 acquires positional information of each craft.

In step S2003, the operation management system 6 designs a partial 4D route with respect to each craft based on various information having been acquired. Also, the operation management system 6 designs a moving appropriable space including a craft whose center of gravity is located on the partial 4D route with respect to each craft. Also, the operation management system 6 designs an appropriable space with respect to a managed body. Also, the operation management system 6 designs a fixed appropriable space including a moving appropriable space (and a partial 4D route) with respect to each craft.

In step S2004, the operation management system 6 plans a 4D route from the start point to the finish point with respect to each craft by connection of the fixed appropriable spaces so that the appropriable space with respect to a managed body and the fixed appropriable space of each craft do not overlap with each other at all clock times.

In step S2005, the operation management system 6 acquires wind state information expressing a wind state predicted at each spot within the management area.

In step S2006, the operation management system 6 modifies at least one of the partial 4D route, the moving appropriable space, and the fixed appropriable space based on the wind state information having been acquired. Also, when there exists uncertainty of the communication quality and the like depending on a spot, the operation management system 6 modifies at least one of the partial 4D route, the moving appropriable space, and the fixed appropriable space considering the uncertainty. When the appropriable space with respect to the managed body and the fixed appropriable space of each craft do not overlap with each other at all clock times and a predetermined evaluation item or a predetermined restriction has been arranged with respect to the 4D route, the operation management system 6 repeatingly continues modification of the partial 4D route, the moving appropriable space, and the fixed appropriable space so as to fulfill them. Also, the operation management system 6 re-plans the 4D route with respect to each craft.

In step S2007, the operation management system 6 transmits the 4D route having been re-planned to each craft. Each craft can fly along the 4D route having been transmitted from the operation management system 6.

In step S2008, the operation management system 6 determines whether or not there is increase or decrease of the craft within the management area. When there is increase or decrease of the craft, the operation management system 6 shifts to step S2001. Thus, even when a new craft enters to the inside of the management area or the craft within the management area retracts to the outside of the management area, the operation management system 6 can re-plan a 4D route responding to such state. When there is not increase or decrease of the craft, the operation management system 6 shifts to step S2009.

In step S2009, the operation management system 6 acquires positional information of each craft.

In step S2010, the operation management system 6 determines whether or not each craft has landed the finish point. When each craft has landed the finish point, the operation management system 6 finishes the present process illustrated in FIG. 20 and FIG. 21. When each craft has not landed the finish point, the operation management system 6 shifts to step S2011 with an object of a craft not having landed the finish point namely a craft in flight.

In step S2011, the operation management system 6 determines whether or not there exists a craft having deviated from the 4D route. When there does not exist a craft having deviated from the route, the operation management system 6 shifts to step S2008 with an object of the craft in flight. When there exists a craft having deviated from the route, the operation management system 6 determines whether or not there exists a craft where both of the boundary surface of the moving appropriable space and the boundary surface of the fixed appropriable space contact with respect to the craft having deviated from the 4D route. Thus, the operation management system 6 determines whether or not there exists a craft where the both interfere with each other. When there exists a craft where the both interfere with each other, the operation management system 6 shifts to step S2012 with an object of the craft where the both interfere with each other. When there does not exist a craft where the both interfere with each other, the operation management system 6 shifts to step S2008 with an object of a craft in flight.

In step S2012, the operation management system 6 determines whether or not there exists a craft capable of re-planning the 4D route. When there exists a craft capable of re-planning the 4D route, the operation management system 6 shifts to step S2001 with an object of a craft capable of re-planning the 4D route. When there does not exist a craft capable of re-planning the 4D route, the operation management system 6 shifts to step S2013 with an object of a craft not capable of re-planning the 4D route.

In step S2013, the operation management system 6 transmits an alarm to fly along the 4D route to the craft not capable of re-planning the 4D route. Thereafter, the operation management system 6 shifts to step S2008 with an object of a craft in flight.

As described above, the operation management system 6 of the present embodiment is an operation management system managing flight of a craft such as a vertical takeoff and landing aircraft. The operation management system 6 includes the 4D route planning unit 8 planning the 4D route of a craft expressed as a series of the position and clock time at which the craft is scheduled to pass. As an appropriable space of the craft not permitting entering of other crafts, the operation management system 6 includes the appropriable space designing unit 9 designing a moving appropriable space that includes the craft and moves along with the mobile object and a fixed appropriable space that includes the moving appropriable space and is along the 4D route. The 4D route planning unit 8 re-plans the 4D route based on the positional relation between the moving appropriable space and the fixed appropriable space during flight of the craft.

Thus, the operation management system 6 of the present embodiment can plan a safe 4D route without the risk of collision against other crafts while permitting deviation of the craft from the route since a twofold appropriable space of the moving appropriable space and the fixed appropriable space is arranged with respect to the craft. Also, since the operation management system 6 can re-plan the 4D route during flight of the craft, even when various phenomena may occur during flight, the operation management system 6 can plan a safe 4D route capable of responding to the phenomena from time to time, and can provide the craft with the safe 4D route. At the same time, since the operation management system 6 plans the 4D route considering not only the position but also the clock time at which the craft is scheduled to pass through, a 4D route crossing with an orbit of a 4D route of other crafts can be permitted, and a 4D route with excellent spatial efficiency can be planned. Also, since the operation management system 6 can re-plan the 4D route during flight of a craft, even when various phenomena may occur during flight, the operation management system 6 can plan a 4D route responding to the phenomena from time to time and provide the craft with the 4D route. Therefore, according to the present embodiment, it is possible to provide the operation management system 6 capable of optimizing an operation route safely and with excellent spatial efficiency responding to various phenomena occurring during flight.

Also, the appropriable space designing unit 9 of the present embodiment includes the moving appropriable space designing unit 14 designing a moving appropriable space, the fixed appropriable space designing unit 13 designing a fixed appropriable space, and the space interference determination unit 15 determining whether or not both of a boundary surface defining the moving appropriable space and a boundary surface defining the fixed appropriable space interfere with each other. When it is determined that the both interfere with each other, the fixed appropriable space designing unit 13 modifies the fixed appropriable space so as to resolve interference of the both. The 4D route planning unit 8 re-plans the 4D route according to the fixed appropriable space having been modified.

Thus, since the operation management system 6 of the present embodiment can surely re-plan a 4D route without the collision risk by a comparatively simple method, a 4D route that is safe and with excellent spatial efficiency can be planned surely and easily and can be provided to a craft.

### Second Embodiment

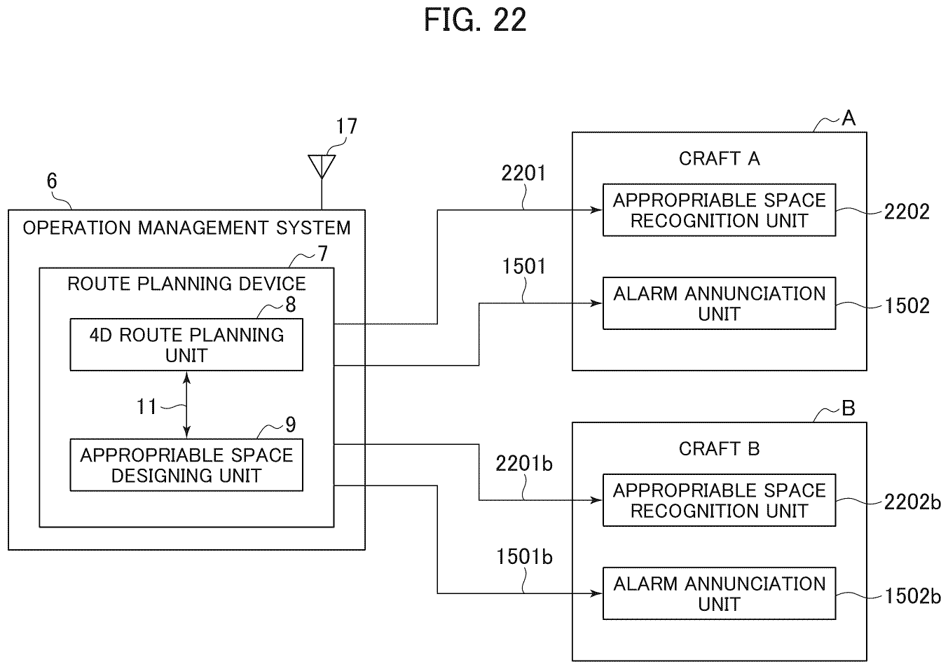

The operation management system 6 of the second embodiment will be explained using FIG. 22. In the operation management system 6 of the second embodiment, with respect to a configuration and a performance similar to those of the first embodiment, explanation will be omitted.

FIG. 22 is a block diagram illustrating an example of a configuration of the operation management system 6 of the second embodiment.

The operation management system 6 of the first embodiment planned the 4D route of each craft based on the fixed appropriable space and the moving appropriable space and transmitted the 4D route to each craft. With respect to the operation management system 6 of the first embodiment, each craft itself is not required to recognize the fixed appropriable space and the moving appropriable space, and the operation management system 6 of the first embodiment can execute operation management of takeoff and landing of each craft. This fact is effective for the operation management system 6 to execute operation management of takeoff and landing of crafts having various specifications in terms that a function for recognizing the fixed appropriable space and the moving appropriable space is not required for each craft.

In the meantime, from the standpoint of the operation management system 6, each craft preferably flies keeping the 4D route having been provided, and it is preferable to avoid such situation that re-designing of the 4D route is executed frequently triggered by interference of the boundary surface of the fixed appropriable space and the boundary surface of the moving appropriable space. From such reason, the operation management system 6 of the second embodiment may be configured as illustrated in FIG. 22.

That is to say, with respect to the operation management system 6 of the second embodiment, the route planning unit 7 has a function of transmitting information 2201, 2201b expressing the fixed appropriable space and the moving appropriable space to each craft A, B respectively in addition to a function of issuing the alarm 1501, 1501b respectively to each craft A, B. Each craft A, B of the second embodiment includes an appropriable space recognition unit 2202, 2202b recognizing the fixed appropriable space 1, 1b and the moving appropriable space 2, 2b from the information 2201, 2201b having been transmitted from the operation management system 6. Also, each craft A, B of the second embodiment can plan a route based on the moving appropriable space 2, 2b and the fixed appropriable space 1, 1b having been recognized. In concrete terms, by determination of each craft A, B itself, each craft A, B of the second embodiment can plan a route deviating from the 4D route 4, 4b transmitted from the operation management system 6 with the limit of within a range where the moving appropriable space 2, 2b having been recognized is included in the fixed appropriable space 1, 1b. Thus, the operation management system 6 of the second embodiment can improve the degree of freedom for each craft A, B to deviate from the 4D route 4, 4b compared to the first embodiment, and can reduce frequency of re-planning of the 4D route 4, 4b.

Also, in the second embodiment, it is not required that all crafts under management of the operation management system 6 include the appropriable space recognition unit. The operation management system 6 of the second embodiment transmits information expressing the fixed appropriable space and the moving appropriable space only to a craft including an appropriable space recognition unit. In spite of such configuration, the operation management system 6 of the second embodiment can reduce frequency of re-planning of the 4D route.

### [Others]

Also, the present invention is not to be limited to the embodiments described above, and various modifications are included. For example, the embodiments described above were explained in detail for easy understanding of the present invention, and are not to be necessarily limited to one including all configurations having been explained. Also, a part of a configuration of an embodiment can be substituted by a configuration of other embodiments, and a configuration of an embodiment can be added with a configuration of other embodiments. Also, with respect to a part of a configuration of each embodiment, it is possible to effect addition, deletion, and substitution of other configurations.

Also, each configuration, function, processing unit, processing means, and the like described above may be achieved, for example, by hardware by designing a part or all thereof with an integrate circuit, and so on. Also, each configuration, function, and the like described above may be achieved by software by that a processor interprets and executes a program achieving respective functions. Information of a program, tape, file, and the like achieving each function can be placed in a recording device such as a memory, hard disk, and SSD (solid state drive) or a recording medium such as an IC card, SD card, and DVD.

Also, with respect to the control line and the information line, those considered to be required for explanation have been shown, and all control lines and information lines required for the product have not necessarily been shown. In fact, almost all configurations can be considered to be mutually connected.

### LIST OF REFERENCE SIGNS

1, 1b: fixed appropriable space,
2, 2b: moving appropriable space,
4, 4b: 4D route (operation route),
5, 5b: positional information,
6: operation management system,
8: 4D route planning unit (route planning unit),
9: appropriable space designing unit,
12: wind state information,
13: fixed appropriable space designing unit,
14: moving appropriable space designing unit,
15: space interference determination unit,
1501, 1501b: alarm,
1601: meteorological area,
1602: flying body,
1610: appropriable space,
1701: aboveground structure,
1801: air exclusion area,
A, B: craft (mobile object)

1. An operation management system for managing operation of a mobile object,
the operation management system comprising:
a route planning unit that plans an operation route of the mobile object expressed as a series of a position and a clock time at which the mobile object is scheduled to pass; and
an appropriable space designing unit that designs, as an appropriable space of the mobile object where entering of another mobile object is not permitted, a moving appropriable space including the mobile object and moving along with the mobile object and a fixed appropriable space including the moving appropriable space and being along the operation route, wherein
the route planning unit re-plans the operation route during operation of the mobile object based on positional relation between the moving appropriable space and the fixed appropriable space.

2. The operation management system according to claim 1, wherein
the appropriable space designing unit includes a moving appropriable space designing unit, a fixed appropriable space designing unit, and a space interference determination unit,
the moving appropriable space designing unit designing the moving appropriable space,
the fixed appropriable space designing unit designing the fixed appropriable space,
the space interference determination unit determining whether or not both of a boundary surface defining the moving appropriable space and a boundary surface defining the fixed appropriable space interfere with each other, and
when it is determined that the both interfere with each other, the fixed appropriable space designing unit modifies the fixed appropriable space, and
the route planning unit re-plans the operation route according to the fixed appropriable space having been modified.

3. The operation management system according to claim 2, wherein,
when it is determined that the both interfere with each other, the fixed appropriable space designing unit modifies the fixed appropriable space of the another mobile object around the mobile object, and
the route planning unit re-plans the operation route of the another mobile object according to the fixed appropriable space of the another mobile object having been modified.

4. The operation management system according to claim 2, wherein,
when it is determined that the both interfere with each other and the fixed appropriable space cannot be modified so as to resolve interference of the both, an alarm is transmitted to the mobile object so as to be operated along the operation route.

5. The operation management system according to claim 2, wherein,
positional information of the mobile object is acquired at a predetermined frequency during a period until the mobile object body reaches a finish point from a start point of the operation route, and, at every acquisition of the positional information, it is determined whether or not the operation route is required to be re-planned.

6. The operation management system according to claim 2, wherein,
the fixed appropriable space designing unit designs the fixed appropriable space so that the both do not interfere with each other even when the mobile object goes around an obstruction by determination of the mobile object itself.

7. The operation management system according to claim 1, wherein,
each of the mobile object and the another mobile object is a flying object, and
the appropriable space designing unit designs at least one of the fixed appropriable space and the moving appropriable space based on wind state information expressing a wind state predicted at each spot within a management area of the operation management system.

8. The operation management system according to claim 1, wherein,
the appropriable space designing unit designs at least one of the fixed appropriable space and the moving appropriable space based on at least one of a position measurement error of the mobile object and quality of communication with the mobile object.

9. The operation management system according to claim 1, wherein,
each of the mobile object and the another mobile object is a flying object, and
the appropriable space designing unit designs an appropriable space not permitting entering of the flying object with respect to at least one of a meteorological area becoming a hamper of flight of the flying object, a flying body and an aboveground structure, and an air exclusion area of the flying object.

10. The operation management system according to claim 1, wherein,
information of the moving appropriable space and the fixed appropriable space is transmitted to the mobile object, and
the mobile object recognizes the moving appropriable space and the fixed appropriable space based on the information having been transmitted, and plans the operation route based on the moving appropriable space and the fixed appropriable space having been recognized.
